(19) United States
(12) Patent Application Publication
(10) Pub. No.: US 2025/0380653 A1
(43) Pub. Date: Dec. 18, 2025

(54) METHOD OF DESIGNING AND OPERATING A COUPLED AQUAPONICS SYSTEM FOR SCALABLE YIELD AND MANAGEMENT

(71) Applicant: Harrisburg University of Science and Technology, Harrisburg, PA (US)

(72) Inventors: Joseph TETREAULT, Harrisburg, PA (US); Todd GUERDAT, Newfields, NH (US); Rachel FOGLE, Harrisburg, PA (US)

(21) Appl. No.: 19/055,761

(22) Filed: Feb. 18, 2025

Related U.S. Application Data
(60) Provisional application No. 63/556,097, filed on Feb. 21, 2024.

(51) Int. Cl. A01G 31/02; A01K 63/04

(52) U.S. Cl. CPC A01G 31/021; A01K 63/045; A01K 63/047

(57) ABSTRACT

A method of designing and operating a coupled aquaponics system comprising (i) a hydroponic production system comprising one or more plant beds, (ii) an aquaculture production system comprising one or more fish rearing tanks, and (iii) one or more biofilters each coupled in parallel to a water pump system for scalable yield and management is disclosed. A coupled aquaponics system is also disclosed.

This application claims the benefit of U.S. Provisional Patent Application Ser. No. 63/556,097, filed Feb. 21, 2024, which is hereby incorporated by reference in its entirety.

### BACKGROUND

Aquaponics is the integration of recirculating aquaculture systems (RAS) and hydroponic cropping systems (HCS) where dissolved nutrients in fish culture water are used to grow crops. Benefits of integrated production include increased revenue from the combination of fish and plant sales, minimized reliance on synthetically derived fertilizers, and both location-independent and season-independent protein and vegetable production in food deserts. Aquaponic systems can be decoupled, where fish and plant production are independent and treated fish culture water is pumped from a RAS to a HCS without recirculation, or coupled, where fish and plant production units share water and water treatment systems. Since water does not flow back from the plant production systems to the RAS in decoupled systems, hydroponic crop culture water quality may be adjusted to meet plant needs and nutrients can be supplemented with synthetic solutions. While this separate optimization for fish and plant growth can achieve similar productivity to individual RAS and HCS, decoupled systems can require greater capital and maintenance costs, more physical space for separate water treatment units, and can be heavily supplemented—up to 49% of the total nutrient mass—with synthetic fertilizers.

Coupled aquaponics is the integration of a RAS and HCS into one system with shared culture water. Water conservation, revenue diversification, location-independent food production, and a reduced reliance on synthetically derived fertilizer salts have been identified as potential benefits of coupled aquaponic production. Despite these potential benefits, it has been difficult for producers to achieve success at the commercial scale. In particular, traditional linear coupled aquaponic system designs are not suited for intensive production due to a lack of scalability and water flow rate optimization to meet the differing requirements for finfish, vegetables, and water treatment management with practices commensurate with commercial scale operations within the individual RAS and HCS industries.

The sharing of water treatment units in coupled systems requires water quality be maintained at compromising conditions to balance both fish and plant health, which often results in diminished plant growth rates and fish stocking densities compared to decoupled systems. Benefits of coupled production over decoupled include reduced capital costs, increased physical space for plants or fish, and the ability to grow plants without the addition of synthetic fertilizers and the environmental impacts associated with their use. Compared to the extensive research and economic success of RAS and HCS as standalone industries, commercial coupled aquaponics is relatively new and has struggled to find financial stability.

Nutrient supply costs—primarily in the form of fish feed—can be identified as a barrier in commercial coupled aquaponic success. Fertilizer salts account for approximately 4% of total expenses for a typical commercial HCS. In contrast, the costs of nitrogen (N) and phosphorus (P) by mass are 7-14 times and 17-88 times more expensive, respectively, than synthetic salts when supplied solely by fish feed. Therefore, a system that loses money from fish production and solely supplies plant nutrients with fish feed will struggle to become profitable. However, an integrated system with a profitable RAS can produce a naturally derived nutrient solution for vegetables that can further supplement income.

Many aquaponic growers develop their own system designs based on a linear process flow to direct water from the fish production system in series with the plant system. Water and waste products flow from the fish rearing unit to a solid waste removal unit, then through biological filtration and hydroponic production units before returning the water to the fish rearing unit. While this linear flow effectively directs unused nutrients from the fish to the plants in small systems, the design lacks scalability to increase yield for greater economic viability due to limited control over water flow rate control and the water treatment processes to meet the specific requirements of crops and fish.

The present application is directed to overcoming these and other deficiencies in the art.

### SUMMARY

One aspect of the present disclosure relates to a method of designing a coupled aquaponics system comprising (i) a hydroponic production system comprising one or more plant beds, (ii) an aquaculture production system comprising one or more fish rearing tanks, and (iii) one or more biofilters each coupled in parallel to a water pump system for scalable yield and management. The method includes determining a plant production value for the hydroponic production system. A required nitrogen production concentration to meet the plant production value is determined. A feed regimen required in the aquaculture production system to provide the required nitrogen production concentration is determined. A fish production value for the aquaculture production system is determined based on the feed regimen and a number of fish. A flow rate to each of the one or more plant beds, one or more fish rearing tanks, and the one or more biofilters is determined based on a target retention time for each of the one or more plant beds, the one or more fish rearing tanks, and the one or more biofilters.

Another aspect of the present disclosure relates to a method of operating a coupled aquaponics system. The method includes operating the coupled aquaponics disclosed herein based on the determined flow rates for each of the one or more plant beds, the one or more fish rearing tanks, and the one or more biofilters to provide the plant production value and the fish production value.

A further aspect of the present disclosure relates to a coupled aquaponics system. The coupled aquaponics system includes a hydroponic production system comprising one or more plant beds, an aquaculture production system comprising one or more fish rearing tanks, one or more biofilters, and a water pump system. The one or more plant beds, the one or more fish rearing tanks, and the one or more biofilters are each coupled in parallel to the water pump system to provide independent retention time and water flow rate for each of the one or more plant beds, the one or more fish rearing tanks, and the one or more biofilters.

The present disclosure provides a parallel unit process design that can result in more intensive fish production and a greater nutrient supply for plant production, leading to the potential for greater economic and space use efficiency. Implementing the same unit process design for coupled aquaponics allows the water flow rate to be optimized for nutrient loading, energy consumption, and physiological requirements to improve fish and crop production rates.

### BRIEF DESCRIPTION OF THE DRAWINGS

FIG. 1 is a block diagram of an exemplary coupled aquaponics system, according to an aspect of the present disclosure.

FIG. 2 is a flow chart of an exemplary method of designing and operating the coupled aquaponics system shown in FIG. 1, according to an aspect of the present disclosure.

FIG. 3 is a table of model data used for determining grow facility area dimensions, according to an aspect of the present disclosure.

FIG. 4 is a table of model data used for determining usage areas of a grow facility, according to an aspect of the present disclosure.

FIG. 5 is a flow chart of an exemplary method of determining a plant production value for the coupled aquaponics system, according to an aspect of the present disclosure.

FIG. 6 is a table of model data used for determining an active grow area for the hydroponic production system of the coupled aquaponics system, according to an aspect of the present disclosure.

FIG. 7 is a table of model data used for determining a maximum number of DWC boards in the hydroponic production system of the coupled aquaponics system, according to an aspect of the present disclosure.

FIG. 8 is a table of model data for determining a number of boards per phase is a three-phased staggered production system model, according to an aspect of the present disclosure.

FIG. 9 is a table of model data for determining a plant production value, according to an aspect of the present disclosure.

FIG. 10 is a table of model data for determining a required nitrogen production level, according to an aspect of the present disclosure.

FIG. 11 is a table of model data for determining a feed rate based on the required nitrogen production level, according to an aspect of the present disclosure.

FIG. 12 is an exemplary flow chart of a method of determining the fish production value, according to an aspect of the present disclosure.

FIG. 13 is a table of model data for determining an average daily feed rate, according to an aspect of the present disclosure.

FIG. 14 is a table of model data for determining a fish production value, according to an aspect of the present disclosure.

FIG. 15 is an exemplary flow chart of a method of determining flow rates for the coupled aquaponics system, according to an aspect of the present disclosure.

FIG. 16 is a table of model data for determining pond bed volumes, according to an aspect of the present disclosure.

FIG. 17 is a table of model data for default setting for stocking density and depth to diameter ratio for determining fish tank volumes, according to an aspect of the present disclosure.

FIG. 18 is a table of model data for determining fish tank volumes, according to an aspect of the present disclosure.

FIG. 19 is a table of model data for determining bioreactor volumes, according to an aspect of the present disclosure.

FIG. 20 is a table of model data for determining aquaculture production system volumes, according to an aspect of the present disclosure.

FIG. 21 is a table of model data for determining flow rates in the coupled aquaponics system, according to an aspect of the present disclosure.

FIG. 22 is a table of model data for the summary of lettuce and fish production, total water volume, and water usage in the coupled aquaponics system according to an aspect of the present disclosure.

### DETAILED DESCRIPTION

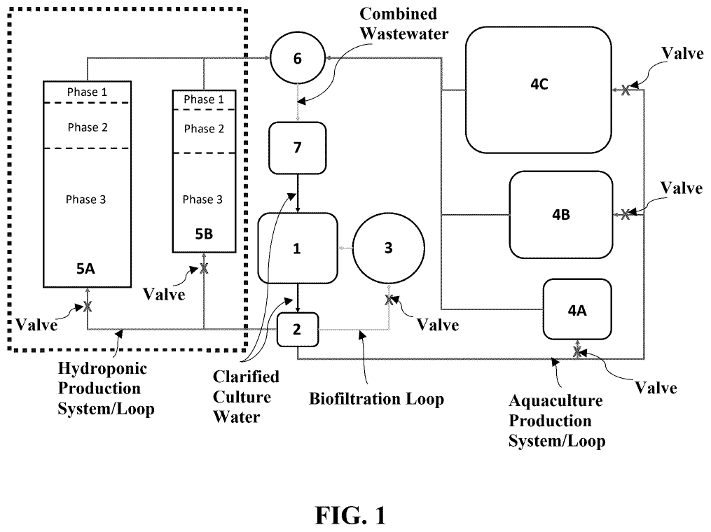

FIG. 1 illustrates an exemplary coupled aquaponics system 100, which illustrates the process flow of the coupled aquaponics system 100. The coupled aquaponics system 100 includes a sump pump reservoir 102 and a water pump 104 coupled to a hydroponic production system 106, a biofiltration system 108, and an aquaculture production system 110. The water pump 104 is coupled in parallel to each of the hydroponic production system 106, the biofiltration system 108, and the aquaculture production system 110. Thus, the retention times within each of the parallel coupled systems (i.e., the hydroponic production system 106, the biofiltration system 108, and the aquaculture production system 110, in one example) can be independently controlled, as further described herein, despite the use of the single water pump 104. A parallel unit process design provides the ability to maintain ideal hydraulic retention times (HRTs) in fish tanks, plant beds, and water treatment units, as described below. A coupled system with appropriate water flow control can permit system scaling and greater fish stocking densities, fish feed rates, and nutrient production rates for plant use compared to linear flow systems.

The presented coupled aquaponics design is comprised of parallel processes for each individual unit or element (i.e. each fish culture tank, hydroponic grow bed, and biofilter to the water pump system, regardless of number). This configuration facilitates control over water flow rates, tank hydraulics, and management protocols to maintain ideal operating conditions (some of which have been identified in the current art) while increasing or decreasing scale or number of units to meet desired production outputs within a given area.

This contrasts with the current art where each unit is positioned in a series. Water flow rate and tank hydraulics in such systems are dependent upon preceding and following units and cannot be effectively managed or scaled without causing operational compromises. Current art within coupled aquaponics design does not allow a scalable design that simultaneously incorporates all the ideal management parameters identified for fish production, plant production, and biofiltration, requiring comprised operating conditions in some, or all, units.

Real time hydraulic retention time and flow rate management are achievable in each individual unit within the presented design without affecting the HRT or flow rate of any other unit within the system. The parallel unit process in the presented design facilitates individualized scaling of each unit without comprising operation. The HRT and flow rate in each element can be managed independently and scaled to meet the current art of fish production, plant production, and water treatment without affecting the performance of any other element.

Flow rates for each of the one or more plant beds, the one or more fish rearing tanks, and the one or more biofilters can be calculated and implemented to provide the plant production value and the fish production value. This results in more intensive fish production and a greater nutrient supply for plant production, leading to the potential for greater economic and space use efficiency.

Referring again to FIG. 1, the coupled aquaponics system 100 advantageously utilizes a scalable parallel unit process design model as described herein. The coupled aquaponics system 100 utilizes a parallel unit process approach for independent hydraulic retention time optimization of each system component, which provides production benefits and scaling opportunities for each of the primary components in the coupled aquaponics system 100. The parallel unit process design can result in more intensive fish production and a greater nutrient supply for plant production, leading to the potential for greater economic and space use efficiency. Implementing the same unit process design for coupled aquaponics allows the water flow rate to be optimized for nutrient loading, energy consumption, and physiological requirements to improve fish and crop production rates.

Referring again to FIG. 1, the biofiltration system 108 includes a biofilter 112, although other numbers of biofilters or other water cleaning apparatuses could be employed in the biofiltration system 108. The hydroponic production system 106 includes one or more plant beds 114(1)-114(2). Although two plant beds 114(1)-114(2) are shown, any number of plant beds could be included in the hydroponic production system 106.

The aquaculture production system 110 includes one or more fish rearing tanks 116(1)-116(3). Although three fish rearing tanks 116(1)-116(3) are shown, any number of fish rearing tanks could be included in the aquaculture production system 110.

The coupled aquaponics system 100 further includes a standpipe well 118 and a solid waste filter 120, although the coupled aquaponics system 100 could include other types and/or numbers of other elements in other combinations.

Referring again to FIG. 1, during use of the coupled aquaponics system 100, clarified system culture water resides in the sump pump reservoir 102. The clarified culture water is pumped by the water pump 104 into each of the hydroponic production system 106, the biofiltration system 108, and the aquaculture production system 110.

As shown in FIG. 1, the coupled aquaponics system 100 includes a number of valves 122 that allow individualized hydraulic control optimization. For example, valves 122(1)-122(6) are provided that can control water flow to the biofilter 112, the fish rearing tanks 116(1)-116(3), and the plant beds 114(1), 114(2), although other types and/or numbers of valves could be provided. The valves 122(1)-122(6) can therefore be utilized to adjust the water flow to the biofilter 112, the fish rearing tanks 116(1)-116(3), and the plant beds 114(1)-114(2) to provide target retention times within those elements of the coupled aquaponics system 100 as described in further detail herein, although other methods and/or devices known in the art can be used to control the water flow. In some examples, the valves 122(1)-122(6) are manually controlled to control the water flow during operation of the coupled aquaponics system 100. In other examples, the operation of the valves 122(1)-122(6) can be autonomously controlled by a computing device configured to autonomously control the water flow within the coupled aquaponics system 100.

Water in the biofiltration system 108 is pumped to the biofilter 112 for nitrification. Valve 122(1) is located between the water pump 104 and the biofilter 112 to control water flow into the biofilter 112. Water then gravity flows back to the sump pump reservoir 102 to complete the loop of the biofiltration system 108.

Water for the aquaculture production system 110 goes from the water pump 104 to the various fish rearing tanks 116(1)-116(3). A separate branch of the aquaculture production system 110 provides inlet water to each fish rearing tank 116(1)-116(3). Each branch has an individual water flow control valve 122(2), 122(3), 122(4) to maintain desired hydraulic retention times (HRTs) for fish at different life stages. In one example, fish rearing tank 116(1) is used for fingerling; fish rearing tank 116(2) is used for juvenile; and fish rearing tank 116(3) is used for grow out. Water in the aquaculture production system 110 then gravity flows from each of the fish rearing tanks 116(1)-116(3) individually and into the standpipe well 118.

Water for the hydroponic production system 106 goes from the water pump 104 to the various plant beds 114(1), 114(2). A separate branch of the hydroponic production system 106 provides inlet water to each of the plant beds 114(1)-114(2). Each branch has an individual water flow control valve 122(5), 122(6) to maintain desired HRTs for different crops or various stages of growth. Water in the hydroponic production system 106 then gravity flows from each of the plant beds 114(1)-114(2) individually and into the standpipe well 118.

The water gravity flowing from the fish rearing tanks 116(1)-116(3) and the plant beds 114(1)-114(2) containing solid waste (fish feces, uneaten feed, plant roots and leaves, etc.) that is transported to the standpipe well 118. Wastewater flows from the standpipe well 118 into the solid waste filter 120, where particulate matter is removed from the coupled aquaponics system 100, allowing clarified water to flow back into the sump pump reservoir 102 for recirculation.

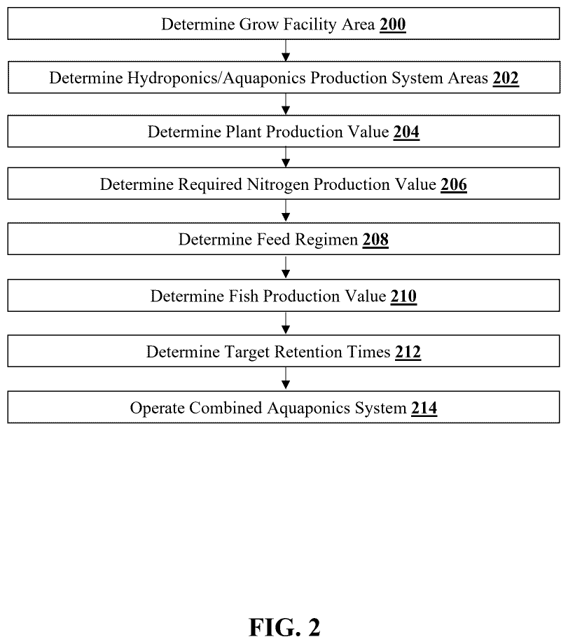

FIG. 2 is a flow chart of an exemplary method of designing and operating the exemplary coupled aquaponics system 100 shown in FIG. 1. Although the method is described with respect to coupled aquaponics system 100, the method could be employed for other coupled aquaponics systems. It is to be understood that the method described herein allows the coupled aquaponics system 100 to be scalable to include additional plant beds, fish rearing tanks, and/or bioreactors or biofilters. The scalable nature of the coupled aquaponics system 100 and the method described herein advantageously scalable yield from the coupled aquaponics system 100.

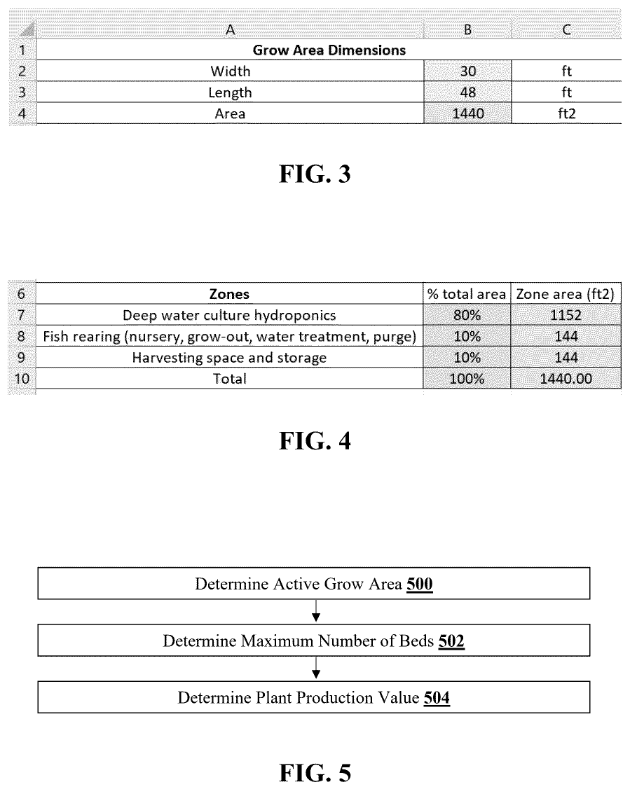

In step 200, a grow facility area is determined based on a user input of the grow facility dimensions. For example, a user can input the length and width available for the grow facility or space to determine the grow facility area as shown in the table in FIG. 3. In this manner, the coupled aquaponics system 100 is scalable and customizable based on the available grow area and can be employed in grow areas of any size. In the example shown in FIG. 3, the grow facility has a width of 30 feet and a length of 48 feet as input by a user. Thus, the grow facility area is calculated to be 1,440 ft².

Next, in step 202, a hydroponics production system area and an aquaculture production system area are determined based on the grow facility area determined in step 200 and a usage area ratio for the hydroponic production system 106 and the aquaculture production system 110 as input by a user. For example, as shown in the table of FIG. 4, the user can input the desired percentage area for the hydroponic production system 106 and the aquaculture production system 110, as well as additional area that can be used for other purposes, such as harvesting space and storage.

In this example, the hydroponic production system usage area ratio is 80% (1152 ft²), the aquaponic production system usage area ratio is 10% (144 ft²), and the additional 10% (144 ft²) is utilized for harvesting space and storage, although other usage area ratios could be employed in other sized grow facility areas. The usage area ratios can be adjusted based on user preferences. In some examples, the hydroponic production system 106 and the aquaculture production system 110 can encompass the entire grow facility area, for example, when external storage is employed. In some examples, the hydroponic production system usage ratio can be between about 80% and about 90% of the grow facility area and the aquaponic production system usage area ratio is between about 10% and about 15% of the grow facility area.

In step 204, a plant production value is determined for the hydroponic production system 106. The plant production value, as used herein, refers to a given yield of individual plants, such as heads of lettuce by way of example only, over a fixed timeframe for the hydroponic production system 106, such as a weekly or yearly yield.

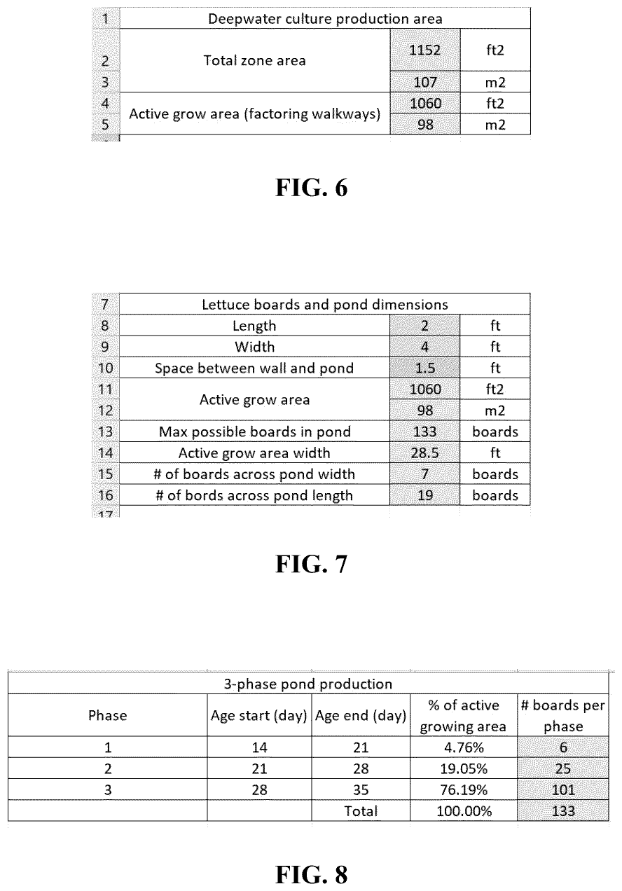

FIG. 5 is an exemplary flow chart of a method of determining the plant production value. In step 500, an active grow area for the one or more plant beds 114(1)-114(2) in the hydroponic production system 106 is determined. The active grow area is determined based on the hydroponic production system area determined in step 202 above and takes into account the area required for walking/harvesting within the hydroponic production system area of the grow facility. The active grow area may also be based on dimensions of the deep water culture (DWC) boards to be utilized in the hydroponic production system 106. FIG. 6 illustrates exemplary values for the determination of the active grow area based on the total area for the hydroponic production system 106. In this example, the active grow area is 1060 ft² of the 1152 ft² that makes up the hydroponic production system area.

Next, in step 502, a maximum number of the DWC boards that can be contained within the active grow area is determined. The maximum number of DWC boards is determined based on the dimensions of the active grow area, as well as the dimensions of DWC boards and the space between the wall and the plant beds 114(1)-114(2) (i.e., the walkways).

Default settings for the length and the width of DWC boards can be used based on common manufacturer dimensions. Default settings can also be employed for the estimated appropriate walking/working space between the plant beds 114(1)-114(2) and the facility wall. Alternatively, the DWC board dimensions and space between the wall and pond values can be adjusted by the user to provide customization.

The maximum number of DWC boards is determined based on either the default settings or the user input values. FIG. 7 is a table showing values for an exemplary determination of the maximum number of DWC boards (133) that can be located in the active grow area based on the identified variables, as well as the number of boards located across the length (19) and width (7) of the pond bed.

In step 504, the plant production value is determined based on the number of DWC boards within the active grow area. In one example, the plant production value is determined based on a three-phased staggered production system model.

In the three-phased staggered production system model, plants are separated into three phases based on the age of the plant, i.e., Phase 1: 14-21 days; Phase 2: 21-28 days; and Phase 3: 28-35 days (as shown in FIG. 8). The percentage of the usage area of the active grow area increases as the plants mature between the phases. The plants are tightly spaced in Phase 1, with spacing increasing in subsequent phases.

FIG. 8 illustrates example values for the “% of active growing area” for each of the phases based on recommended leafy green plant spacing for DWC production. The model assumes adequate lighting is provided for all plants. The number of boards per phase is determined from the DWC board dimensions and the “% of active growing area” required for each phase. In this example, the 133 boards are distributed as follows: Phase 1 (6 boards); Phase 2 (25 boards); and Phase 3 (102 boards).

The number of DWC boards per phase (as shown in FIG. 8) can be used to determine the number of plants per phase. The number of plants per phase is based on the grow requirements for the specific plant (such as heads of lettuce by way example only) being grown on the DWC boards. The number of plants remains constant at each phase for consistent nutrient requirements and harvesting.

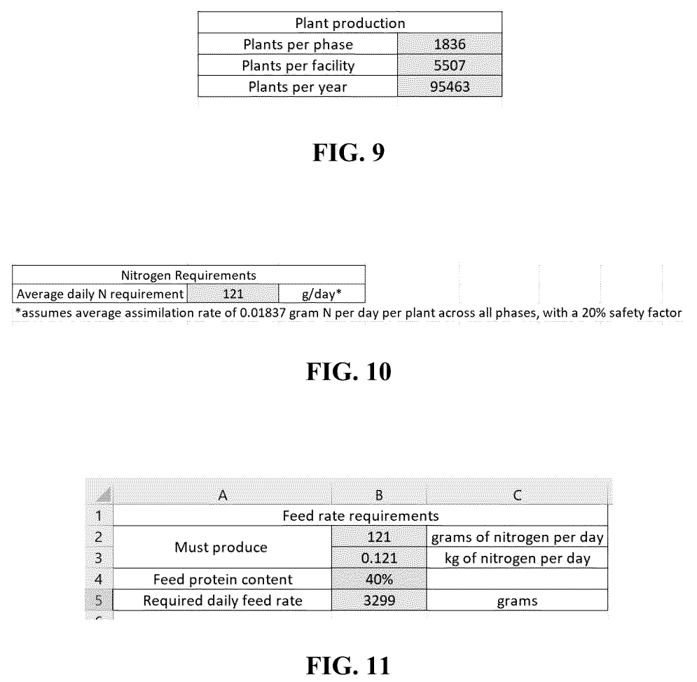

The number of plants per phase is calculated using the number of DWC boards required for Phase 3 production and the ideal spacing of the plants (such as lettuce heads) to determine the number of plants per board. The consistent number of plants per phase and the weekly harvest is used to calculate the projected yearly plant yield, which in this example provides the plant production value. FIG. 9 illustrates exemplary values for the determination of the plants per phase (1,836), the plants in the grow facility (5,507) based on the number of DWC boards, and the plant production value (95,463), which in this case is the yearly plant yield.

Referring again to FIG. 2, in step 206 a required nitrogen production level is determined to meet the plant production level determined in steps 204 (FIG. 2) and 504 (FIG. 5). As used herein, the nitrogen production value refers to a mass of nitrogen over a fixed timeframe. The required nitrogen production value is the mass of nitrogen over a fixed timeframe required to support the calculated number of plants to provide the plant production value determined in step 204, as well as the type of plant.

The required nitrogen production level to meet the plant production level is determined based on an average nitrogen assimilation rate per plant and a safety factor. Referring now to FIG. 10, in one example, previous research has demonstrated that a lettuce plant requires 0.0187 grams of nitrogen per day. In this example, the safety factor is about 20% and is used to ensure that enough nitrogen is always provided for the hydroponic production system 106.

In step 208, a feed regimen for the aquaculture production system 110 is determined. The feed regimen is determined to provide the required nitrogen production level as determined in step 206. As used herein, the feed regimen refers to the feed rate (in mass of feed per fixed timeframe) to support fish production at a feed conversion ratio between 1.0 and 2.0, such as a daily feed rate for the aquaponics production system. FIG. 11 illustrates values for an exemplary determination of a feed regimen based on the exemplary required nitrogen production level determined in FIG. 10. The feed regimen is based on a protein content percentage for the feed provided. In this example, a default protein content percentage of 40%. The user can adjust the protein content percentage of the feed based on the type of feed employed. In other examples, the feed protein content value is about 32 percent to about 40 percent.

Referring again to FIG. 2, in step 210, a fish production value for the aquaculture production system 110 is determined based on the feed regimen and number of fish in the aquaculture production system 110. As used herein, the fish production value refers to a given yield of individual fish at an average harvest weight over a fixed timeframe.

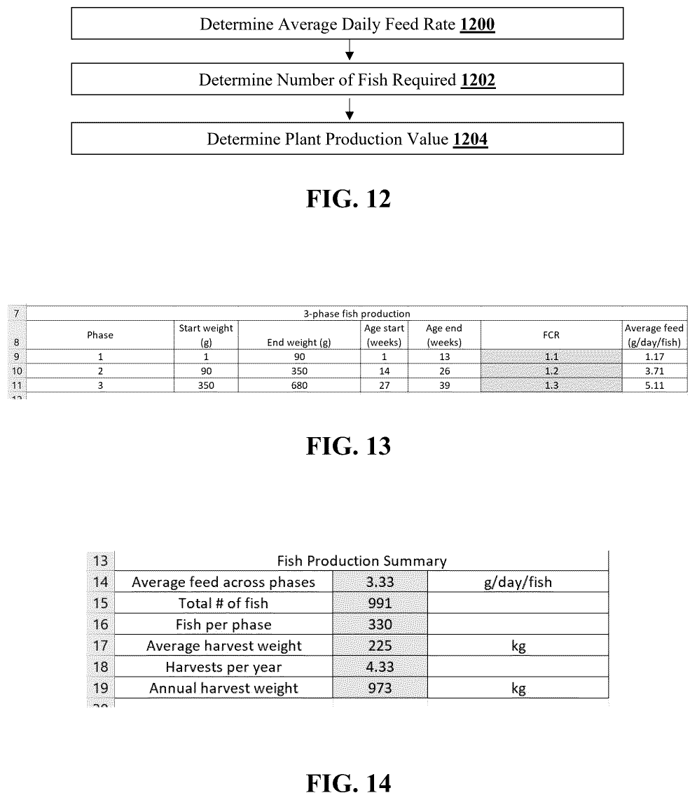

FIG. 12 is an exemplary flow chart of a method of determining the fish production value. In step 1200, an average daily feed rate is determined for the aquaculture production system 110. In this example, the average daily feed rate used to determine the fish production value is determined based on a three-phased fish production model that projects fish growth and time required in each stage of production. Each phase is associated with a different feed conversion ratio (FCR).

In one example, in the three-phased fish production model, fish are separated into three phases based on the age and growth of the fish, i.e., Phase 1: 1-13 weeks and 1-90 grams; Phase 2: 14-26 weeks and 90-350 grams; and Phase 3: 27-39 weeks and 350-680 grams (as shown in FIG. 13). The weights and time frames have been established in the RAS industry and assume that proper water quality metrics are being maintained.

The default settings for the FCR values may also be based on RAS industry standards for warmwater fish production. The FCR values can be adjusted by the user if a different feed conversion efficiency is expected. As shown in FIG. 13, the average daily feed rate is determined for each phase of fish production. In the example, shown in FIG. 13, the average daily feed rates are as follows: Phase 1: 1.17; Phase 2: 3.71; Phase 3: 5.11.

Next, in step 1202, the number of fish required in each phase is determined based on the average daily feed rate and the feed conversion ratios for each of the three phases. In one example, the total number of fish is determined based on the average feed rate across the three phases and the feed regimen determined in step 208. The total number of fish can then be used to determine the number of fish per phase. FIG. 14 illustrates exemplary data based on an average feed rate across the three-phases of 3.33 g/day/fish. The total number of fish is determined to be 991, which results in 330 fish per each phase.

In step 1204, the fish production value is determined based on the number of fish required in each phase. The projected harvest data can be calculated both in individual and yearly intervals. In the example shown in FIG. 14, an average harvest weight of 225 kilograms and an annual harvest weight of 973 kilograms are determined.

Referring again to FIG. 2, in step 212, a flow rate to each of the one or more plant beds 114(1)-114(2), one or more fish rearing tanks 116(1)-116(3), and the one or more bioreactors or biofilters is determined. The flow rate is determined based on a target retention time for each of the one or more plant beds 114(1)-114(2), the one or more fish rearing tanks 116(1)-116(3), and the one or more bioreactors or biofilters, as well as the volumes of those elements. The flow rate provides the ideal inlet water rate for each unit, which can be manually or autonomously controlled using the valves shown in FIG. 1. The target retention times can be based on default settings based on commonly used parameters in coupled aquaponics system 100 or can be adjusted by the user to optimize the coupled aquaponics system 100, i.e., to optimize the plant and fish production values.

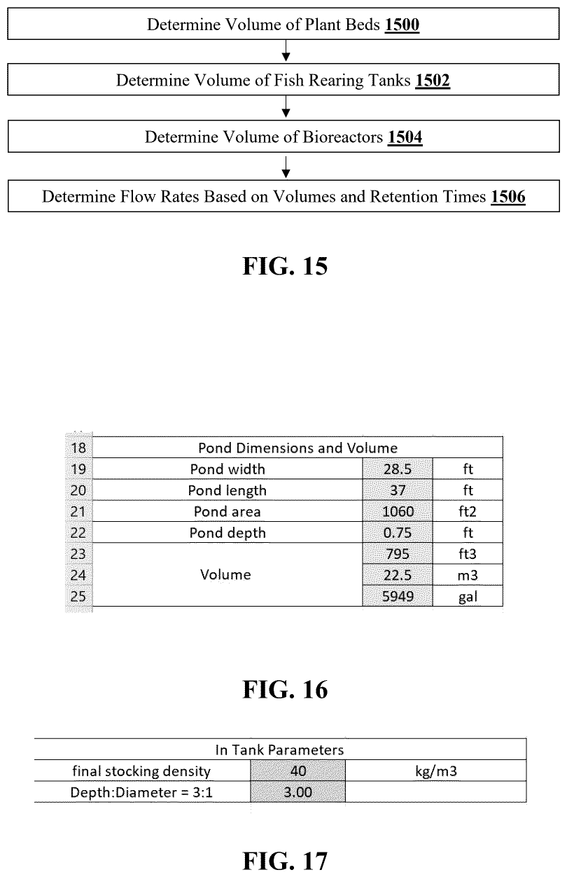

FIG. 15 is an exemplary flow chart of a method of determining flow rates for the coupled aquaponics system 100. In step 1500, plant bed volumes, for example the volumes of plant beds 114(1)-114(2) as shown in FIG. 1, are determined. The plant bed volumes are determined based on the active grow area for the hydroponics production system as determined in step 1200 (FIG. 12), which is based on the user inputs of the grow area dimensions (e.g., FIG. 3) and the usage ratios (e.g., FIG. 4). The pond depth is input based on typical grow conditions for DWC systems. FIG. 16 illustrates values for an exemplary pond bed volume determination in which the pond bed has a volume of 795 ft³. The plant bed volume can be adjusted by altering the open space or space between the wall and the pond (e.g., FIG. 7).

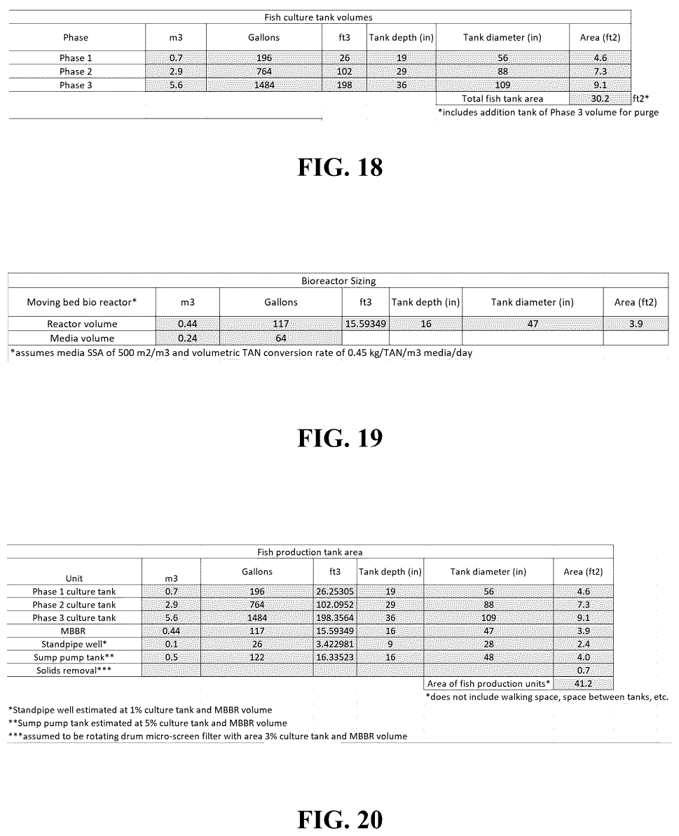

In step 1502, fish tank volumes, for example the volumes of fish rearing tanks 116(1)-116(3) as shown in FIG. 1, are determined. The fish rearing tank volumes are determined based on the aquaculture production system 110 area (e.g., FIG. 4), the number of fish per phase (e.g., FIG. 14), and default settings for stocking density and a depth to diameter ratio. FIG. 17 illustrates exemplary values for the stocking density and the depth to diameter ratio. The default stocking density is based on the maximum stocking density for the most commonly used oxygen source in aquaponics. The default setting for the depth to diameter ratio is based on the ideal ratio for swirling solids removal within a fish tank. Both default settings can be adjusted based on specific user needs. In some examples, the stocking density value is about 40 kilograms per cubic meter to about 80 kilograms per cubic meter and the depth to diameter ratio is about 3:1 to about 6:1. FIG. 18 illustrates values for an exemplary calculation of the required water volume needed for the fish production calculated in FIG. 14 and the settings in FIG. 18.

The floor surface area for all fish rearing tanks, such as fish rearing tanks 116(1)-116(3), is also provided. The required water volume needed in each fish rearing tank for the fish production value can also be determined as shown in FIG. 18.

Next, in step 1504, bioreactor volumes are determined based on the feed regimen calculated to support plant and fish population in step 208 (FIG. 2). The tank volume, media volume, and floor surface area of the bioreactor required for nitrification is determined based on the calculated feed rate (e.g., FIG. 11). FIG. 19 illustrates values for an exemplary calculation of the bioreactor sizing.

The sizing of the fish tanks and the biofilter 112 can be used to determine the sizing of other elements in the system, including the stand-pipe well 118, the sump pump reservoir 102, and the solid waste filter 120, as shown in FIG. 1. FIG. 20 illustrates exemplary data and assumptions for determining the volumes of those additional elements.

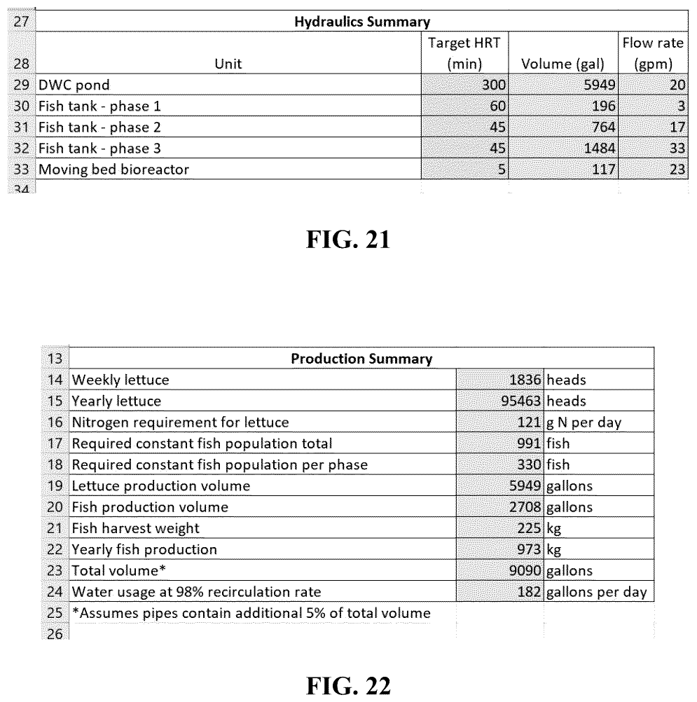

Referring again to FIG. 15, in step 1506, the flow rates to the one or more plant beds 114(1)-114(2), the one or more fish rearing tanks 116(1)-116(3), and the one or more biofilters 112 are determined. The flow rates are calculated based on the determined volumes in steps 1500-1504 for those elements and a target retention time. FIG. 21 illustrates values for an exemplary calculation of flow rates. The default values for the target HRT (min) are commonly used values for warmwater fish production in recirculating aquaculture systems and for leafy green production in DWC hydroponics. Adjusting the target HRTs will recalculate the ideal inlet flow rate for a specific unit.

Referring again to FIG. 2, in step 214, the coupled aquaponics system 100 is operated based on the determined flow rates for each of the one or more plant beds 114(1)-114(2), the one or more fish rearing tanks 116(1)-116(3), and the one or more biofilters 112 to provide the plant production value and the fish production value. The flow rates can advantageously be individually controlled using the valves 122(1)-122(6) shown in FIG. 1. This allows optimizing each of the HRT values.

In one example, the valves 122(1)-122(6) are manually adjusted to provide the determined flow rates in step 212. In another example, the valves 122(1)-122(6) are autonomously adjusted, such as by a coupled computing device configured to perform one or more of the methods described herein, to provide the determined flow rates. Step 214 can further include determining an adjusted flow rate based on change in the target retention time for any of the one or more plant beds 114(1)-114(2), the one or more fish rearing tanks 116(1)-116(3), and the one or more biofilters 112 and operating the aquaponics system to provide the adjusted flow rate.

FIG. 22 illustrates data for an exemplary production summary for the coupled aquaponics system 100 based on the model data disclosed herein.

### EXAMPLES

### Example 1—Fish Culture Tank Design Influences Fish Health and Productivity

In RAS, round tanks with low HRTs and a vertical water inlet manifold spanning the entire tank depth provide a self-cleaning property by creating a circular water flow where waste is drawn to a center drain for rapid removal. The time required to fully pump and evacuate one equivalent tank water volume is described as the nominal HRT. The actual HRT of a tank may be influenced by a combination of flow rate, water inlet and outlet design, tank shape, and the tank diameter: depth ratio, and are typically greater than the nominal HRT. Precise inlet and outlet flow rate control is required to maintain water quality and the ideal HRT across fish life stages. Water velocity is typically maintained from 0.5-2.0 fish body lengths second⁻¹ to exercise fish and swirl waste to the center drain. Typical fish tank HRTs in systems built after 2010 were less than 60 minutes. Systems with high culture tank HRTs can suffer from reduced dissolved oxygen (DO) concentrations, organic carbon (OC) accumulation from suspended solid waste, and toxic total ammoniacal nitrogen (TAN) accumulation. A study sought to identify the ideal single hydraulic loading rate for all units in a linear system. The highest flow rate resulted in an estimated fish tank HRT of 2.78 hours. The authors acknowledged that such high fish tank HRTs may result in poor water quality in high density culture fish systems but were limited in fish tank control due to the 6 h HRT chosen to meet plant needs in the hydroponic unit, which resulted in a flow rate of 2-3 L min⁻¹. While this system design successfully grew a variety of crops and maintained adequate fish health at a small scale, direct adoption in commercial-scale operations would not be suitable for intensive fish growth or nutrient production for plant use due to inadequate water quality management.

### Example 2—Effective Solid Waste Removal Improves Fish Health

The effective removal of RAS solid waste, which primarily consists of fish feces, uneaten feed, and sloughed scales, is required to maintain optimal water quality parameters and the requisite high water recirculation rates. Solid waste accumulation can negatively affect DO concentration, TAN concentration, and downstream biofiltration, while also increasing potential pathogen proliferation. Commercial RAS commonly use granular filters for physical removal of solids >20 microns, or rotating drum microscreens—often fitted with filter screens ranging in mesh sizes of 40-80 microns—for mechanical removal. To work effectively, granular filters must be sized to maintain an HRT that does not limit other units, while screen filters are controlled by a float switch which triggers a high-pressure spray and does not rely on or affect the flow rate of water from the culture tank. Thus, effective use of microscreen drum filters can remove one of the major impediments to process optimization.

Ineffective solids removal has been identified as a primary limiting factor for optimizing fish production in RAS and coupled aquaponic systems. Many commercial operations and research-based systems use clarifiers and other gravimetric solids separation methods. Optimally designed gravity-based clarification systems can remove solids >100 microns, with effectiveness depending on clarifier HRT providing sufficient time for particles to settle. However, extending clarifier HRT will then reduce the flow rate and self-cleaning properties of preceding culture tanks or will require excessively large clarifying units to achieve the optimal tank flow rates and required HRTs for optimal solids removal efficiency.

A commercial scale system achieved stocking densities commensurate with commercial RAS but required two 3.8 m³ clarifiers with a combined area of 5.26 m² and a 20-minute HRT to remove solids from four 7.8 m³ fish culture tanks with a combined area of 29.2 m². While increasing clarifier diameter and utilizing baffles to lengthen the traveling path and settling period of solids allowed greater fish stocking densities, flow control was restricted in preceding and following units and the clarifiers consumed physical space that could otherwise be used for plant and/or fish production. Additionally, intensive clarifier maintenance is required to prevent the resuspension of solids and accumulation of organic carbon. Long periods between solids purging can also result in resuspension through denitrification, which produces nitrogen bubbles that get caught in the microbial biomass and cause masses of sediment to float to the surface and re-enter the flow stream. Nitrous oxide (N₂O) is an intermediary of the denitrification process and a potent greenhouse gas with radiative forcing 265 times greater than carbon dioxide. These emissions represent both nutrient loss for plant utilization and environmental consequences. Due to the compromises associated with intensive fish production and gravimetric solids removal, lower fish stocking densities and feed rates than in commercial RAS are commonly used in coupled aquaponic systems to prevent solids accumulation and maintain safe water quality.

### Example 3—Biofiltration is Essential to Fish Health and Productivity

After solids removal, culture water still contains dissolved ammonia (NH³/NH⁴⁺) that is lethal to fish in low concentrations. Nitrate (NO³⁻) is also the predominant form of nitrogen utilized for most crop plants in commercial and research HCS. For these reasons, NH⁴⁺ must be converted into NO³⁻ through nitrification. To achieve this, microbial biofilters are colonized with and support the growth of the two primary species of autotrophic nitrifying bacteria, Nitrosomonas and Nitrobacter, responsible for the two-step process where NH⁴⁺ is converted into nitrite (NO²⁻) and then into NO³⁻. A moving bed biofilm reactor (MBBR) with media designed to maximize surface area for biofilm production are often used in RAS and coupled aquaponics. Appropriate biofilter sizing and HRT are crucial for fish health and maximizing nitrification. Calculating biofilter volume is a multi-step process based on estimates of daily NH⁴⁺ production rates from feed regimens and NH⁴⁺ conversion rates of specific media. The recommended HRT for a MBBR in commercial RAS production is 2-5 minutes. Maintaining ideal MBBR retention times is not possible in a linear process flow system unless the preceding fish tanks and solids removal system and the following hydroponic units all use the same water flow rates.

Effective solids removal prior to biofiltration is required to achieve maximum nitrification as increased particulate OC promotes the growth of heterotrophic bacteria that outcompete desired autotrophs and reduces nitrification efficiency. Even if a linear process flow system with gravimetric solids removal was operated to achieve ideal biofilter HRT, overall production could still be limited. If the clarifier was sized for appropriate solids removal, crop production area would be reduced as gravimetric solids removal devices occupy valuable space and are not ideal for commercial-scale production. Nitrification efficiency would be reduced if the clarifier was undersized with poor solids removal. A linear process flow is not suitable for commercial production intending to profit from fish and plant sales because it cannot simultaneously meet the differing hydraulic requirements for fish, plant, and water quality management under intensive growing conditions. Maximizing system productivity requires independently managed unit processes that can each adjust water flow rate for HRT optimization to facilitate efficient function at any scale.

### Example 4—Feed Rate and Nitrogen Production

As noted above, nutrients from fish feed are significantly more expensive than synthetic fertilizers, making it difficult for coupled aquaponic production to be profitable when fish are not a viable revenue source. Profitable fish production in RAS is generally achieved through intensification of the process to make efficient use of the inputs. While tilapia has historically been a common RAS and aquaponic fish, feed practices and stocking densities can vary between industries. Intensive RAS tilapia feed rates are based on fish age, with fry receiving up to 30% of the system biomass weight in feed per day before tapering gradually to approximately 1.5% of the system biomass in feed per day as fish reach harvest mass. Tilapia are commonly harvested at 680 g when feed conversion ratio (FCR) increases and the return on weight gain to cost of feed is diminished. Conversely, many coupled aquaponic systems have lower stocking densities and either feed a daily rate between 2% and 5% of the initial fish biomass without adjustment to account for growth or feed several times a day until visible satiation to provide consistent nutrient inputs without waste accumulation. Restrictive feed rates and lower stocking densities in coupled aquaponics will reduce the fish production rate and the rate of dissolved nutrient output available for crop growth, which further supports the need to adopt a parallel unit process design for intensive fish production when nutrient supplementation is not desired or possible.

Excluding carbon, N is often the most required nutrient by mass for effective plant growth. Because of its importance by mass to plant growth and the cost disparity between sourcing N from fish feed and conventional fertilizer salts, the potential of greater N production from intensive fish rearing is vital when considering coupled aquaponic management. TAN production (solubilization and excretion of N in feed) from the fish unit can be utilized to calculate the potential plant productivity of such a system. Daily TAN production can be calculated using the following equation:

P_{TAN}=(FR*PC*0.092)/1000

where P_{TAN} is daily TAN production (g day⁻¹), FR is daily feed rate (kg day⁻¹), PC is the protein content of feed (%), and 0.092 is the average percent of the feed mass excreted as ammonia. The production of TAN was normalized to 1 m³ of fish at each reported stocking density and feed rate to accurately compare nutrient production. Increased fish stocking density and feed rate results in greater specific daily N production.

Lettuce or other leafy greens are the most commonly grown aquaponic crops and can be used as a model crop to demonstrate the effect of maximizing nutrient production by the fish and biofilter units. An average N assimilation rate of 0.0184 g day⁻¹ plant⁻¹ has been presented for a common three-phased lettuce growing method to calculate the ideal feed rate to plant ratio. The greater specific N output achieved using the parallel unit process design, fish stocking density, and daily feed rate from would result in the most heads of lettuce grown per year. More intensive fish production uses less space and supports a greater hydroponic growing area, resulting in more efficient space utilization and greater profitability of both the RAS and HCS components in coupled aquaponic systems.

### Example 5—System Surface Area and Design Assumptions

Greenhouse systems are popular because modifications can be made to allow season-independent growth while harnessing natural light and heat. This design is based on commonly available commercial greenhouse dimensions of 29.26 m long and 9.14 m wide, with a total surface area of 267.56 m². The floor area of the greenhouse is divided into four primary zones for efficient area utilization as shown in Table 1, below.

TABLE 1
Area allotment for greenhouse zones. The approximate percentage
of the total area used for the primary zones of a commercial
coupled aquaponics greenhouse are indicated.

| Greenhouse Zone | % of Area | Area (m²) |
|---|---|---|
| Hydroponics | 75% | 200.67 |
| Fish Rearing and Water Treatment | 15% | 40.13 |
| Harvesting Space | 5% | 13.38 |
| Storage | 5% | 13.38 |
| Total | 100% | 267.56 |

Most of the area is devoted to hydroponic production as this will provide the most consistent revenue source. Nile tilapia (Oreochromis niloticus) and lettuce (Lactuca sativa) are some of the most commonly grown fish and vegetable, respectively, according to recent aquaponic practitioner surveys and are the basis for all subsequent fish and plant management guidelines. To ensure consistency in estimated yields, it is assumed that supplemental light, air temperature control, and water temperature control are used to maintain ideal growing conditions throughout the year.

### Hydroponics

### Example 6—Scalable Hydroponic Production: Deep Water Culture

In deep water culture (DWC) hydroponics, plants float on polystyrene rafts in ponds that allow root systems to be fully submerged in nutrient-rich water. The ponds provide security against crop loss since sufficient standing water is retained in the event of equipment failure. Furthermore, supplemental lighting is simplified, and harvesting is streamlined in DWC because plants are easily accessible at a uniform elevation. Commercially available rafts are often 0.61 m wide and 1.22 m long, with a variety of options for spacing of grow holes.

Head lettuce, such as Butterhead lettuce, is well-suited to DWC production because it has a lightweight head that can be easily supported by a raft and a relatively small root mass that will not clog the pond. A five-week seed to harvest timeline for Butterhead lettuce has been established where seedlings are kept in a separate germination area for two weeks before being transplanted into a DWC system for three weeks. Initial transplants require less space than mature plants, and staggering growth into three one-week phases provides consistent production and efficient space utilization. Ideal spacing for lettuce growth is used to determine the total number of heads across the three different phases and weekly harvest estimates for a system. Each week, lettuce on the phase 3 rafts is harvested, and plants within each phase progress into the next phase growing area. Based on the established growing area and the recommended spacing for lettuce, a 200.67 m² area could contain 11,067 plants and produce 3,689 heads per week or 191,828 heads per year, as shown in Table 2 below.

TABLE 2
Phases of hydroponic lettuce growth. Hydroponic lettuce production
was divided into three one-week phases. Each phase increases
in area as individual maturing plants required a greater
spacing. The same number of plants at each phase allows
consistent production rates and the development of an average
daily N requirement for the hydroponic unit.

| | Age | Spacing | % of Pond | Area | Rafts | Plants |
|---|---|---|---|---|---|---|
| Phase | (days) | (m² plant⁻¹) | Area | (m²) | Phase⁻¹ | Phase⁻¹ |
| 1 | 14 | 0.003 | 5% | 10.0 | 14 | 3,689 |
| 2 | 21 | 0.010 | 19% | 38.1 | 52 | 3,689 |
| 3 | 28 | 0.041 | 76% | 152.5 | 205 | 3,689 |

### Example 7—Scalable Hydroponic Production: Nitrogen Requirements

Nitrogen (N) is an essential macro-nutrient and is required for lettuce growth. Smaller plants assimilate a smaller N mass each day while larger plants assimilate a greater mass each day. Maintaining a constant number of plants at each phase allows the calculation of an accurate average daily fish N production rate for ideal plant growing requirements using the following equation:

$${P}_{N} = ( ( plants {phase}^{- 1} * phases ) * {assimilation}_{N} ) + SF$$

where P_{N} is the production of g N day⁻¹ required for ideal lettuce growth, phases is the number of age-based growing sections, assimilation_{N} is average g N day⁻¹ required by a single lettuce plant, and SF is a safety factor to ensure an adequate nutrient mass is always available. The average N assimilation rate of a lettuce plant in a three-phased DWC growing method is 0.01837 g N plant-1 day⁻¹. Based on this assimilation rate and the addition of a 20% safety factor to ensure sufficient nutrient supply, a DWC pond with 11,067 lettuce plants evenly separated across three age-based phases would require 244 g N day⁻¹.

### Example 8—Scalable RAS Production: Fish Feed Rate Calculations

Fish waste contains high concentrations of total ammoniacal nitrogen (TAN). A daily fish feed rate to produce a desired N loading rate from fish waste can be calculated using the following equation:

$$g feed = {P}_{TAN} / PC / 0.092$$

where g feed is g feed day⁻¹ required to produce a specific N mass, P_{TAN} is the specific production rate of N as g TAN day⁻¹, PC is the protein content of the feed (%), and 0.092 is the average percent of the feed mass excreted as ammonia. A feed rate of 6.63 kg day⁻¹ is required to provide 244 g N day⁻¹ from feed with a 40% protein content.

### Example 9—Scalable RAS Production: Fish Production Schedule

Staggered tilapia production is used to ensure a constant feed and N production rates and to increase fish harvest frequency. Estimates for tilapia growth rates under intensive aquaculture production standards from fry to harvest weight were used to calculate a daily feed rate per fish in conjunction with the following equation:

$$g feed {fish}^{- 1} = \frac{( {weight}_{final} - {weight}_{initial} ) * FCR}{( {age}_{final} - {age}_{initial} )}$$

where g feed fish⁻¹ is the average feed consumption day⁻¹ fish⁻¹ over a chosen timeframe, weight_{final} is the average weight fish⁻¹ in g at the end of this phase, weightᵢₙᵢₜᵢₐₗ is the weight fish⁻¹ in g at the start of this phase, FCR is the average feed conversion ratio at the given age range, age_{final} is fish age in days at the end of the phase, and ageᵢₙᵢₜᵢₐₗ is the fish age in days at the start of the phase. Phased production is determined by fish age, desired harvest frequency, or desired number of culture tanks. A five-phased production system can be utilized for a seven-week harvest interval with fry starting at 0.5 g and harvest when growth rates plateau and feed conversion ratio (FCR) increases upon reaching an average weight of 624 g as shown in Table 3 below.

TABLE 3
Phased fish production based on desired daily N production rate.
This five-phased approach consistently maintains a desired
system feed rate to produce the required daily N mass for ideal
plant growth. Fish number is kept constant across each phase.
Feed rate increases as fish weight and FCR increase to ensure
growth rates commensurate with the RAS industry.

| | Start Age | End Age | Start | End | | Feed Rate (g |
|---|---|---|---|---|---|---|
| | in Days | in Days | Weight | Weight | | day⁻¹ |
| Phase | (Weeks) | (Weeks) | (g) | (g) | FCR | fish⁻¹) |
| 1 | 1 (1) | 49 (7) | 0.5 | 24 | 1.1 | 0.54 |
| 2 | 50 (8) | 98 (14) | 24 | 130 | 1.2 | 2.65 |
| 3 | 99 (15) | 147 (21) | 130 | 277 | 1.4 | 4.29 |
| 4 | 148 (22) | 196 (28) | 277 | 439 | 1.6 | 5.40 |
| 5 | 197 (29) | 245 (35) | 439 | 624 | 1.8 | 6.94 |

The average feed rate fish⁻¹ day⁻¹ across all phases is used to determine the total fish population required to consume a desired total feed rate to produce specific N mass each day, and can be calculated using the following equation:

$$average g feed {fish}^{- 1} = \frac{( {\sum }_{1}^{n} {phase}_{1} + {phase}_{2} + … + {phase}_{n} )}{n}$$

where average g feed fish⁻¹ is the average g feed fish⁻¹ day⁻¹ across all growth phases, n is the total number of growth phases, and phase is the g feed fish⁻¹ day⁻¹ for each phase. In the five-phased system described in Table 3, the average feed rate fish⁻¹ across all phases is 3.96 g day⁻¹. This average feed rate fish⁻¹ and the total system feed rate from the equation above can be used to calculate the total fish population that must remain evenly distributed across all growth phases to fully consume the total system feed rate to produce the required daily N loading rate. The total fish population can be calculated using the following equation:

$${fish}_{total} = \frac{feed {rate}_{system}}{average g feed {fish}^{- 1} {phase}^{- 1}}$$

where fishₜₒₜₐₗ is the number of fish required across all growth phases to produce the desired mass of N day⁻¹, feed rate system is the g feed day⁻¹ required to produce the desired mass of N day⁻¹, and average g feed fish⁻¹ phase⁻¹ is the average g feed fish⁻¹ day⁻¹ across all growth phases. A system feeding 6.63 kg day⁻¹ with an average feed rate of 3.96 g feed fish⁻¹ phase⁻¹, would require 1,674 fish evenly distributed across all growth phases. A five-phased grow-out would require 335 fish phase⁻¹. Each harvest would yield 209 kg of fish, for a yearly production of 1,553 kg.

### Example 10—Scalable RAS Production: Fish Culture Tank Volume

The water volume of a tank can be calculated when the number of fish, final weight, and maximum stocking density are known using the following equation:

$$V = \frac{{fish}_{tank}}{( \frac{{density}_{final}}{{weight}_{harvest}} )}$$

Where V is the volume of water required in a fish tank in m³, fishtank is the number of fish in each tank, density_{final} is the maximum desired stocking density in kg m⁻³, and weightₕₐᵣᵥₑₛₜ is the average weight in kg of fish at harvest. The tank volume for each of this five-phased production method will house 335 fish and a maximum stocking density of 40 kg m⁻³ and is shown in Table 4 below.

TABLE 4
Tank volume based on final fish weight and stocking density.
This five-phased approach maintains a consistent fish population
at each phase but conserves the physical footprint of fish
production by sizing each tank to the final estimate average
weight of an individual fish at the end of each phase.

| | Fish | Final Fish | Tank Volume |
|---|---|---|---|
| Phase | Population | Weight (g) | (m³) |
| 1 | 335 | 24 | 0.20 |
| 2 | 335 | 130 | 1.09 |
| 3 | 335 | 277 | 2.23 |
| 4 | 335 | 439 | 3.67 |
| 5 | 335 | 624 | 5.22 |

A 20% safety factor for fish numbers in Phase 1 may be beneficial to account for higher juvenile mortality rates.

### Example 11—Scalable RAS Production: Moving Bed Biofilm Reactor Volume

Moving bed biofilm reactors (MBBR) are commonly used in RAS to transform fish lethal TAN into the safer nitrate using multiple heterotrophic bacteria whose growth is facilitated on aerated media. Growth media volume in an MBBR is dependent on daily TAN production rates from fish waste, and can be calculated using the following equation:

$${V}_{media} = ( {P}_{TAN} / {SSA}_{media} ) + SF$$

where V_{media} is the volume of growth media in m³, P_{TAN} is the daily TAN production in g day⁻¹, SSA_{media} is the specific surface area in m² m⁻³ of the media for bacteria growth, and SF is a safety factor to ensure complete nitrification occurs. A system that produces 244 g N day⁻¹, uses media with a 500 m² m⁻³ SSA, and has a 20% safety factor would require 0.59 m³ of MBBR media. MBBR is effective when 55% full of media. An MBBR requiring 0.59 m³ of media would necessitate a total volume of 1.07 m³.

### Example 12—Individual Unit Hydraulic Control

The isolated loops in a parallel unit process design provide water flow rate control to each component, which can then be operated at ideal conditions regardless of scale as shown in Table 5 below.

TABLE 5
Individual hydraulic management in a parallel unit process
design. The HRT for each unit was recommended in RAS
and HCS literature. The individual flow rates were based
on those recommendations and the volume of each unit
determined by the equations presented above.

| | | Example | Example |
|---|---|---|---|
| | HRT | Volume | Flow Rate |
| Unit | (min) | (m³) | (gal min^{- 1}) |
| DWC Pond | 300 | 36.9 | 32.5 |
| Fish Tank | 35-53 | 0.20 | 1.51-1.00 |
| (Phase 1) | | | |
| Fish Tank | 35-53 | 5.22 | 39.4-26.0 |
| (Phase 5) | | | |
| MBBR | 3 | 1.07 | 94.2 |

Additional loops with different flow rates can be added, or removed, without affecting existing units. This allows multiple hydroponic methods to increase crop diversity and the opportunity to incorporate fingerling production with reduced flow rates, while maintaining the precise HRTs identified to meet differing fish and plant requirements.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, therefore, is not intended to limit the claimed processes to any order except as may be specified in the claims. Accordingly, the invention is limited only by the following claims and equivalents thereto.

What is claimed is:

1. A method of designing a coupled aquaponics system comprising (i) a hydroponic production system comprising one or more plant beds, (ii) an aquaculture production system comprising one or more fish rearing tanks, and (iii) one or more biofilters each coupled in parallel to a water pump system for scalable yield and management, the method comprising:
determining a plant production value for the hydroponic production system;
determining a required nitrogen production level to meet the plant production level;
determining a feed regimen required in the aquaculture production system to provide the required nitrogen production level;
determining a fish production value for the aquaculture production system based on the feed regimen and a number of fish;
determining, based on a target retention time for each of the one or more plant beds, the one or more fish rearing tanks, and the one or more biofilters, a flow rate to each of the one or more plant beds, one or more fish rearing tanks, and the one or more biofilters; and
operating the coupled aquaponics system based on the determined flow rates for each of the one or more plant beds, the one or more fish rearing tanks, and the one or more biofilters to provide the plant production value and the fish production value.

2. The method of claim 1 further comprising:
determining a hydroponics production system area and an aquaculture production system area based on a grow facility area and a usage area ratio for the hydroponic production system and the aquaculture production system;
determining volumes for the one or more plant beds based on the hydroponics production system area;
determining volumes for the one or more fish tanks based on the aquaculture production system area;
determining the flow rates to the one or more plant beds based on the determined volumes and the target retention time for the one or more plant beds; and
determining the flow rates to the one or more fish tanks based on the determined volumes and the target retention time for each of the one or more fish tanks.

3. The method of claim 2, wherein operating the aquaponics system comprises manually adjusting valves coupled to the one or more plant beds and the one or more fish tanks to provide the determined flow rates.

4. The method of claim 2, wherein operating the aquaponics system comprises autonomously adjusting valves coupled to the one or more plant beds and the one or more fish tanks to provide the determined flow rates.

5. The method of claim 2, wherein operating the aquaponics system further comprises determining an adjusted flow rate based on change in the target retention time for any one of the one or more plant beds, the one or more fish rearing tanks, and the one or more biofilters.

6. The method of claim 2,
determining volumes for the one or more biofilters based on the feed regimen calculated to support plant and fish population within the coupled aquaponics system; and
determining the flow rates to the one or more biofilters based on the determined volumes and the target retention time for each of the one or more biofilters within the coupled aquaponics system.

7. The method of claim 1, wherein determining the plant production value comprises:
determining an active grow area for the one or more plant beds in the hydroponics production system;
determining a maximum number of deep water culture (DWC) boards that can be contained within the active grow area;
determining the plant production value based on the number of DWC boards within the active grow area.

8. The method of claim 7, wherein the plant production value is determined based on a three-phased staggered production system model.

9. The method of claim 1, wherein the fish production value is determined based on a three-phase fish production model.

10. The method of claim 9, wherein each of the three phases has a different feed conversion ratio.

11. The method of claim 10, wherein determining the fish production value comprises:
determining an average daily feed rate for the aquaculture production system;
determining a number of fish required in each phase based on the average daily feed rate and the feed conversion ratios for each of the three phases; and
determining the fish production value based on the number of fish required in each phase.

12. The method of claim 11, further comprising determining volumes of the one or more fish tanks based on a stocking density value and a depth to diameter ratio value.

13. The method of claim 12, wherein the stocking density value is about 40 kilograms per cubic meter to about 80 kilograms per cubic meter and the depth to diameter ratio is about 3:1 to about 6:1.

14. The method of claim 13 further comprising determining a required water volume needed for the fish production value.

15. A coupled aquaponics system comprising:
a hydroponic production system comprising one or more plant beds;
an aquaculture production system comprising one or more fish rearing tanks;
one or more biofilters; and
a water pump system, wherein the one or more plant beds, the one or more fish rearing tanks, and the one or more biofilters are each coupled in parallel to the water pump system to provide independent retention time and water flow rate for each of the one or more plant beds, the one or more fish rearing tanks, and the one or more biofilters.

16. The system of claim 15, wherein a volume for each of the one or more biofilters is based on a feed regimen calculated to support plant and fish population within the coupled aquaponics system.

17. The system of claim 15, wherein an area of the hydroponics production system and an area of the aquaculture production system area are based on a grow facility area and a usage area ratio for the hydroponic production system and the aquaculture production system.

18. The system of claim 17, wherein a volume for each of the one or more plant beds is based on the hydroponics production system area and a volume for each the one or more fish tanks based on the aquaculture production system area.

19. The system of claim 15 further comprising:
valves coupled to the one or more plant beds and the one or more fish tanks to provide independent flow rates.

20. The system of claim 15 further comprising:
a computing device coupled to the one or more valves to control operation of the one or more valves.
